(19) United States
(12) Patent Application Publication
(10) Pub. No.: US 2016/0341871 A1
(43) Pub. Date: Nov. 24, 2016

(54) LIGHT GUIDE PLATE, BACKLIGHT MODULE AND NARROW-BORDER DISPLAY DEVICE

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/425,006

(22) PCT Filed: Jan. 5, 2015
(86) PCT No.: PCT/CN2015/070126

§ 371 Date: Feb. 28, 2015

(30) Foreign Application Priority Data
Dec. 10, 2014 (CN) 201410758614.6

(51) Int. Cl. F21V 8/00

(52) U.S. Cl. CPC G02B 6/0021; G02B 6/0055; G02B 6/0068

(57) ABSTRACT

The invention provides a light guide plate (LGP), and a light output surface near a light incident end of the LGP has an elongated groove extending along the widthwise direction of the LGP and for installing a light source assembly. The invention further provides a backlight module including the LGP, an optical film assembly, a reflective sheet and a light source assembly; the light source assembly is T-shaped and includes a horizontal portion and a vertical portion installed with multiple LEDs, the vertical portion is disposed in the elongated groove, the horizontal portion is disposed covering the elongated groove and contacting with a top surface of the LGP. The invention further provides a narrow-border display device including a display panel and the backlight module.

### BACKGROUND OF THE INVENTION

1. Field of the Invention

The present invention relates to the field of display technology, and particularly to a light guide plate, a backlight module and a narrow-border display device.

2. The Related Arts

In existing products, a display device usually is constituted by a display panel, an optical film set, a double-sided tape, a light source, a light guide plate, a plastic frame and a metal frame. The display panel, the optical film set, the light guide plate and the reflective sheet are stacked in that order and then are accommodated into the plastic frame and further disposed on the metal frame, the display panel is fixed with the optical film set and the plastic frame by the double-sided tape.

With the development of mobile communications products, cost-effective designs have become one of important directions of product designs. For existing designs, in order to reduce the cost, many manufacturers eliminate the metal frame in the display device. However, the overall structural strength of the display device would be greatly degraded, and the reliability of product quality cannot be guaranteed.

### SUMMARY

Accordingly, in order to overcome the drawbacks in the prior art, the invention provides a light guide plate, a backlight module and a narrow-border display device, which can ensure the compact structures for the backlight module and display device without the metal frame and improve the overall structural strength and reliability of product.

In order to achieve the above objective, the invention provides the following technical solution that:

A light guide plate includes a light output surface and a bottom surface. The light incident end of a side of the light guide plate is corresponding to a light source assembly. The light output surface of the side of the light guide plate near the light incident end is formed with an elongated groove, the elongated groove is formed extending along the widthwise direction of the light guide plate for accommodating the light source assembly.

In an embodiment, the light output surface of the light guide plate is further formed with a first accommodating groove neighboring with the elongated groove, and the first accommodating groove is used for installing an optical film assembly.

In an embodiment, the sidewall of the first accommodating groove near the elongated groove is a reflective surface, the intersection angle between the sidewall and the bottom surface of the first accommodating groove is an obtuse angle.

In an embodiment, the bottom surface of the light guide plate is formed with a second accommodating groove for installing a reflective sheet.

In an embodiment, the elongated groove is communicated with the second accommodating groove.

The invention further provides a backlight module. The backlight module includes a light guide plate, an optical film assembly, a reflective sheet and a light source assembly. A light output surface of the light guide plate is formed with an elongated groove, the light source assembly is T-shaped and includes a horizontal portion and a vertical portion installed with a plurality of LEDs, the vertical portion is inserted into the elongated groove, the horizontal portion is disposed covering the elongated groove and tightly contacting with a top surface of the light guide plate.

In an embodiment, the light output surface of the light guide plate is further formed with a first accommodating groove neighboring with the elongated groove, and the optical film assembly is disposed in the first accommodating groove.

In an embodiment, another surface of the light guide plate opposite to the light output surface is formed with a second accommodating groove, and the reflective sheet is disposed in the second accommodating groove.

In an embodiment, the sidewall of the first accommodating groove near the elongated groove is a reflective surface, an intersection angle between the sidewall and a bottom surface of the first accommodating groove is an obtuse angle.

In addition, the invention provides a narrow-border display device. The narrow-border display device includes a display panel and the above-described backlight module. A depth of the first accommodating groove is the same as a thickness of the optical film assembly, and the display panel is tightly contacted with a side of the horizontal portion of the light source assembly and adhered onto the light output surface of the light guide plate.

The invention forms an elongated groove for installing a light source assembly at an end of the light output surface of the light guide plate, so that the light source assembly can be compactly installed on the light guide plate, and therefore the compact structures for the backlight module and the display device still can be ensured under the circumstance of without the metal frame, the overall structural strength and reliability of product are improved.

### BRIEF DESCRIPTION OF THE DRAWINGS

The above and other aspects, features and advantages of embodiments of the invention will be more apparent from the following detailed description taken in conjunction with the accompanying drawings, in which:

FIG. 1 is a schematic structural view showing a light output surface of a light guide plate according to embodiment 1 of the invention;

FIG. 2 is a schematic structural view showing another surface of the light guide plate according to the embodiment 1 of the invention;

FIG. 3 is a schematic partial structural view of a backlight module according to embodiment 2 of the invention; and

FIG. 4 is a schematic partial structural view of a display device according to embodiment 3 of the invention.

### DETAILED DESCRIPTION OF EMBODIMENTS

In order to make the objectives, technical solutions and advantages of the invention that will be more clearly understood, the invention is further described by using various embodiments with reference to accompanying drawings. It should be understood that, the described concrete embodiments only are used for illustrating the invention but not to limit the invention.

### Embodiment 1

As shown in FIG. 1, a light guide plate 10 according to the embodiment 1 of the invention includes a light output surface and a bottom surface opposite to the light output surface. One side of the light guide plate 10 is the light incident end, the light output surface of the light guide plate 10 near the light incident end is formed with an elongated groove 13. The elongated groove is formed extending along the widthwise direction of the light guide plate 10 and configured for accommodating a light source assembly.

The light output surface of the light guide plate 10 is further formed with a first accommodating groove 11 neighboring with the elongated groove 13, and the first accommodating groove 11 is configured for installing an optical film assembly.

A sidewall 14 of the first accommodating groove 11 near the elongated groove is a reflective surface, and an intersection angle between the sidewall 14 and a bottom surface of the first accommodating groove 11 is an obtuse angle, that is, the sidewall 14 generally is with an oblique surface. By such design, light rays emitted from the light source assembly would partly strike on the sidewall 14 and then be reflected back to the interior of the light guide plate 10, which can avoid the light leakage at the sidewall 14 resulting in local high brightness of display panel and light pollution and meanwhile can increase the utilization ratio of light rays.

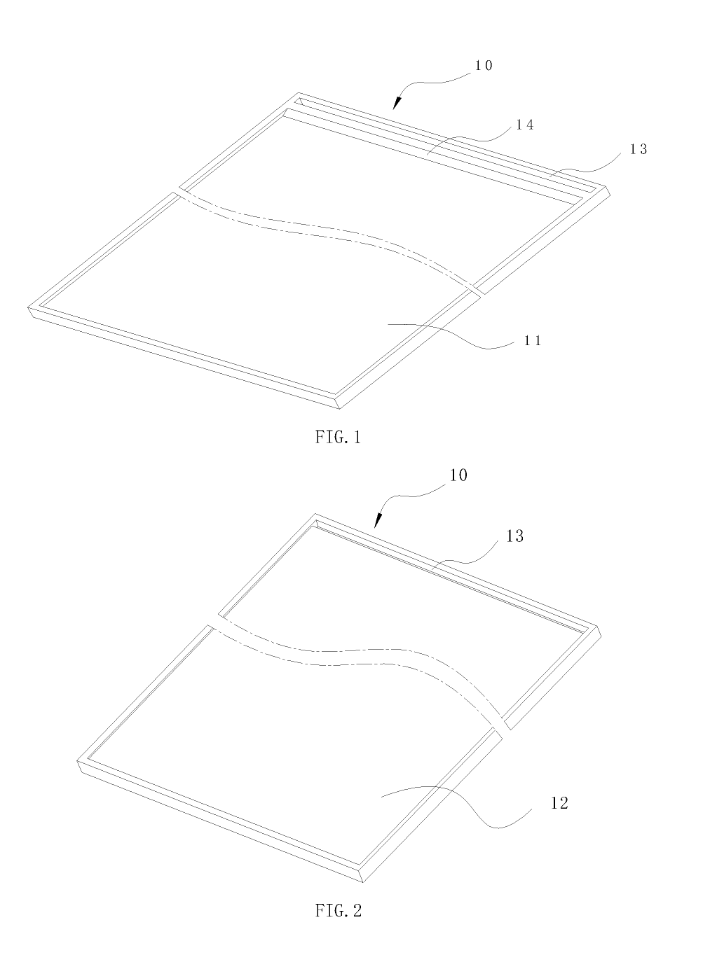

As shown in FIG. 2, the bottom surface of the light guide plate 20 is formed with a second accommodating groove 12 for installing a reflective sheet. In this embodiment, the elongated groove 13 and the second accommodating groove 12 are communicated with each other.

Sum up, this embodiment forms the elongated groove 13 for installing a light source assembly at an end of the light output surface of the light guide plate near the light incident end, so that the light source assembly can be compactly installed on the light guide plate 10; moreover, the light output surface is further formed with the first accommodating groove 11 for installing an optical film assembly, the bottom surface of the light guide plate 10 is formed with the second accommodating groove 12 for installing a reflective sheet, and therefore under the circumstance of without the metal frame, by using the light guide plate 10 to integrate the light source assembly, the optical film assembly and the reflective sheet together, the space utilization is high, the product structure is more compact, and the overall structural strength and reliability of product can be improved.

### Embodiment 2

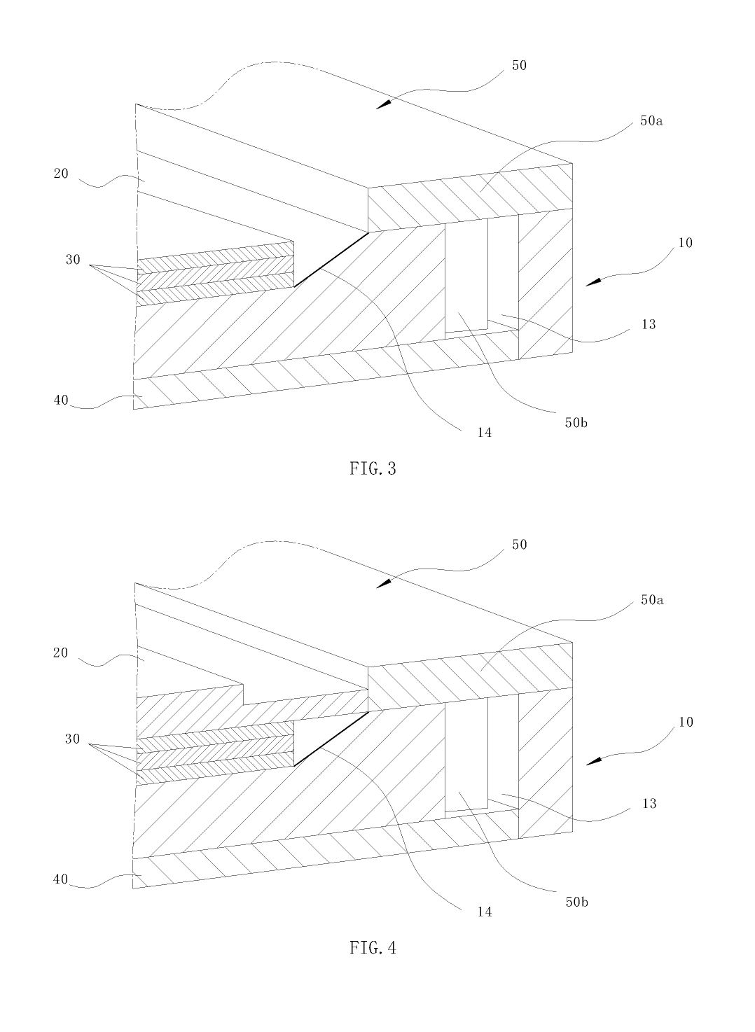

Referring to FIG. 1 through FIG. 3 together, a backlight module provided by the embodiment 2 of the invention includes the light guide plate 10 as described in the embodiment 1, an optical film assembly 30, a reflective sheet 40 and a light source assembly 50. The light output surface of the light guide plate 10 is formed with an elongated groove 13. The light source assembly 50 is T-shaped and includes a horizontal portion 50a and a vertical portion 50b installed with multiple (i.e., more than one) LEDs. The vertical portion 50b is inserted into the elongated groove 13, the horizontal portion 50a is disposed covering the elongated groove 13 and being tightly contacted with a top surface of the light guide plate 10.

More specifically, the vertical portion 50b of the light source assembly 50 is disposed in the elongated groove 13, and the optical film assembly 30 is a multi-layered film structure and disposed in the first accommodating groove 11. The reflective sheet 40 is installed in the second accommodating groove 12 and for reflecting light rays incident on the bottom surface of the light guide plate 10 to the light output surface.

In this embodiment, the elongated groove 13 is communicated with the second accommodating groove 12, the vertical portion 50b of the light source assembly 50 which is installed with multiple LEDs is disposed in the elongated groove 13, and a bottom surface of the vertical portion 50b is abutted with a top surface of the reflective sheet 40. Because the horizontal portion 50a of the light source assembly 50 is disposed covering the elongated groove 13 and being tightly contacted with the top surface of the light guide plate 10, and the vertical portion 50b is abutted with the top surface of the reflective sheet 40, the fixing of the light source assembly 50 is more stable and reliable. In addition, it can be understood that, the lower end of the vertical portion 50b may be suspended and thus without contacting with the reflective sheet 40, or the elongated groove 13 is not communicated with the second accommodating groove 12 and the lower end of the vertical portion 50b is abutted with the bottom surface of the elongated groove 13.

Sum up, the backlight module in this embodiment uses the light guide plate 10 to integrate the light source assembly, the optical film assembly 30 and the reflective sheet 40 together, so that the space utilization is high, the product structure is more compact, and the overall structural strength and reliability of product are improved.

### Embodiment 3

In conjunction with FIG. 4, a narrow-border display device provided by this embodiment of the invention includes a display panel and the backlight module as described in the above embodiment 2. Herein, the display panel 20 is a liquid crystal panel. In this embodiment, a depth of the first accommodating groove 11 is equal to a thickness of the optical film assembly 30, an edge of the top surface of the light incident end of the light guide plate 10 is disposed with an adhesive layer (not shown), the display panel 20 is tightly contacted with a side of the horizontal portion 50a of the light source assembly 50 and adhered onto the light output surface of the light guide plate 10. By such arrangement, the display panel 20 and the horizontal portion 50a of the light source assembly 50 are installed at a same horizontal level and contacted with each other, the light source assembly 50 and the light guide plate 10 are tightly contacted with each other, and the reflective sheet 40 is disposed in the lower end of the light guide plate 10, so that this embodiment of the invention can achieve the compact structure, and by sufficiently using the light guide plate 10 to integrate the other structures of the display device together, the space utilization is high, the structural strength of product is large.

Moreover, because the structures such as metal frame and plastic frame are eliminated, the border of the display device can be narrower.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide plate comprising a light output surface and a bottom surface, wherein the light incident end of a side of the light guide plate is corresponding to a light source assembly, the light output surface of the side of the light guide plate near the light incident end is formed with an elongated groove, the elongated groove is formed extending along the widthwise direction of the light guide plate for accommodating the light source assembly.

2. The light guide plate as claimed in claim 1, wherein the light output surface of the light guide plate is further formed with a first accommodating groove neighboring with the elongated groove, and the first accommodating groove is used for installing an optical film assembly.

3. The light guide plate as claimed in claim 2, wherein the sidewall of the first accommodating groove near the elongated groove is a reflective surface, the intersection angle between the sidewall and the bottom surface of the first accommodating groove is an obtuse angle.

4. The light guide plate as claimed in claim 1, wherein the bottom surface of the light guide plate is formed with a second accommodating groove for installing a reflective sheet.

5. The light guide plate as claimed in claim 4, wherein the elongated groove is communicated with the second accommodating groove.

6. The light guide plate as claimed in claim 2, wherein the bottom surface is formed with a second accommodating groove for installing a reflective sheet.

7. The light guide plate as claimed in claim 6, wherein the elongated groove is communicated with the second accommodating groove.

8. The light guide plate as claimed in claim 3, wherein the bottom surface is formed with a second accommodating groove for installing a reflective sheet.

9. The light guide plate as claimed in claim 8, wherein the elongated groove is communicated with the second accommodating groove.

10. A backlight module comprising a light guide plate, an optical film assembly, a reflective sheet and a light source assembly; wherein the light output surface of the light guide plate is formed with an elongated groove, the light source assembly is T-shaped and comprises a horizontal portion and a vertical portion installed with a plurality of LEDs, the vertical portion is inserted into the elongated groove, the horizontal portion is disposed covering the elongated groove and tightly contacting with the top surface of the light guide plate.

11. The backlight module as claimed in claim 10, wherein the light output surface of the light guide plate is further formed with a first accommodating groove neighboring with the elongated groove, and the optical film assembly is disposed in the first accommodating groove.

12. The backlight module as claimed in claim 11, wherein another surface of the light guide plate opposite to the light output surface is formed with a second accommodating groove, and the reflective sheet is disposed in the second accommodating groove.

13. The backlight module as claimed in claim 12, wherein the sidewall of the first accommodating groove near the elongated groove is a reflective surface, the intersection angle between the sidewall and a bottom surface of the first accommodating groove is an obtuse angle.

14. A narrow-border display device comprising a display panel and the backlight module as claimed in claim 10, wherein the depth of the first accommodating groove is the same as the thickness of the optical film assembly, the display panel is tightly contacted with a side of the horizontal portion of the light source assembly and adhered onto the light output surface of the light guide plate.

15. The narrow-border display device as claimed in claim 14, wherein the light output surface of the light guide plate is further formed with a first accommodating groove neighboring with the elongated groove, and the optical film assembly is disposed in the first accommodating groove.

16. The narrow-border display device as claimed in claim 15, wherein another surface of the light guide plate opposite to the light output surface is formed with a second accommodating groove, and the reflective sheet is disposed in the second accommodating groove.

17. The narrow-border display device as claimed in claim 16, wherein the sidewall of the first accommodating groove near the elongated groove is a reflective surface, the intersection angle between the sidewall and the bottom surface of the first accommodating groove is an obtuse angle.
